(19) United States
(12) Patent Application Publication
(10) Pub. No.: US 2022/0153514 A1
(43) Pub. Date: May 19, 2022

(54) PROFILE FOR A CONTAINER, METHODS FOR MANUFACTURING A PROFILE, BASE STRUCTURE FOR A CONTAINER AND CONTAINER

(71) Applicant: Maersk Container Industry A/S, Tinglev (DK)

(72) Inventors: Lars LÜBKER, Haderslev (DK); Thomas Therkel NIELSEN, Tinglev (DK); Hans-Erik KIIL, Sønderborg (DK)

(21) Appl. No.: 17/433,051

(22) PCT Filed: Feb. 26, 2020
(86) PCT No.: PCT/EP2020/055045

§ 371 Date: Aug. 23, 2021

(30) Foreign Application Priority Data
Feb. 27, 2019 (DK) PA 2019 70134

(51) Int. Cl. B65D 90/02; B65D 88/12; B23K 11/10; B23K 11/11

(52) U.S. Cl. CPC B65D 90/027; B65D 88/121; B23K 2101/12; B23K 11/11; B23K 11/105

(57) ABSTRACT

The invention relates to a profile in a container, where a profile (5, 6, 7, 8, 101) comprising a cross section where at least a part of the cross section over a length of the profile is provided with a crumple zone, which crumple zone has a critical buckling load being smaller than the critical buckling load for zones abutting the crumple zone. The invention further relates to a method of manufacturing a profile for a container, where one or more profiles (5, 6, 7, 8, 101) in the container (1) is provided with a crumple zone, which crumple zone has a critical buckling load being smaller than the rest of the profile (5, 6, 7, 8, 101). The invention also relates to abase structure for a container, comprising a pair of bottom side rails, a front sill (4) in one end and a door end in an opposite end, a number of crossmembers (8) placed in parallel with the front sill (4) and door end and extending from a bottom side rail (2) in one side of the container (1) to a bottom side rail (2) at the other side of the container (1), wherein the crossmember (8) comprises a cross-section, where at least a part of the cross section over a length of the profile (5, 6, 7, 8, 101) is provided with a crumple zone, which crumple zone has a critical buckling load being smaller than the critical buckling load for zones abutting the crumple zone.

The invention relates to a profile in a container.

The invention further relates to a method of manufacturing a profile for a container.

The invention further relates to a base structure for a container comprising a pair of bottom side rails, a front sill in one end and a door end in an opposite end, a number of crossmembers placed in parallel with the front sill and door end and extending from a bottom side rail in one side of the container to a bottom side rail at the other side of the container.

Profiles are usually used in construction of containers, e.g. railway containers, intermodal containers, reefer containers or shipping containers

Such profiles provides strength to the construction and at the same time showing lower weight that if solid rods or beams are used.

Containers has for many years been considered to be a sufficient rigid construction and are used until too severe damage causes need for repair or replacement.

Due to a rigid construction, several types of damage at local parts of the container lead to an impact and damage of other parts of the container, causing that large areas of the container and several components are to be repaired or renewed.

The invention brings the possibility to reduce distribution of damage caused by impact during handling of containers or when placing containers on uneven surfaces.

From EP 2881339 B1 a cargo transportation container is known, where profiles are provided with reduced width or height in order to save weight, but still providing strength to the construction.

A classic prior art profile is designed to have the stiffness needed to fulfil the required max deformations during static load cases, and as a consequence of use of materials of same wall thicknesses for body and for the flanges of the profile, the critical buckling load for the body of the profile is relative high, meaning the profile is very robust regarding transfer of high level of impact forces related to impact accidents, and the profile does only absorb impact energy to a low extend.

The problem to be solved is to provide a profile with a crumple zone to reduce distribution of damages related to impact accidents from one component or profile to another, and at same time provide the profile with sufficient stiffness to take the load under normal operation.

The new profile is designed to have the stiffness needed to perform as specified regarding deformations during static load cases, however the new design at same time absorbs higher level of impact energy during impact accidents and consequently the profile transfer less level of forces and cause less damages to other parts of the container structure.

The characteristics of the new profile is that the critical buckling load is significantly reduced by reduced thickness of the body of the profile. To have unchanged stiffness and unchanged characteristics related to static load, such as unchanged moment of inertia, the cross sectional area of the flanges is increased to compensate for the smaller cross-sectional area of the body. The cross-sectional area of the flanges is increased by either increase of width, increase of thickness or combinations of increase of width and thickness of the flanges. The increase of cross-sectional area for the flanges can be made by selection of plates of increased dimensions or by welding together more plates.

The orientation of static load on the profile is the same as the orientation of impact load, e.g. the static load is vertical downwards and the impact load is vertical upwards. The new profile is optimized to take a defined static load and at same time have a reduced critical buckling load. The reduced critical buckling load for the new profile results in larger deformations of the profile when subjected to impact forces having opposite direction of the static load forces. The larger deformations of the profile means increased absorption of energy during impact.

Reduction of the critical buckling force for a sidewall/body of the crossmember profile is obtained by relocation of material from the walls of the profile to the flanges of the profile.

In the following sidewall/body will be used describing parts of the profile connecting the flanges. In other words, the material between the flanges is sidewall/body of the profile. As a simple example, in an I-profile the upper and lower flanges are connected by a central part, being the sidewall/body.

A profile which is often exposed to damage, is a crossmember, which is a part of a floor section of a container. The crossmembers are therefore described throughout this application to illustrate the invention, but it is clear that other profiles within the construction of a container can take advantage of same invention.

Examples of such profiles can be bolster, gooseneck rails, sideposts and outriggers.

A crumple zone will in this application be understood as a zone or area of a profile provided with a change in material thickness, change in material strength, change in geometry or in combinations of this, providing a predetermined zone of a profile or compilation of profiles where the zone is configured for deformation without or only slightly transferring deformation to neighbouring structure elements.

Providing a crumple zone to profiles of a container lead to a number of improvements, for example a reduced number of serious impact damages of floor and corner structure, and thereby reducing repair costs related to serious impact damages.

In the following examples of profiles, crossmembers will be described but the invention will relate to profiles in the container in general.

Forming a crossmember with reduced thickness dimension for sidewalls/bodies of the crossmember enables the crossmember to absorb an increased portion of the impact energy in case of an impact accident, and consequently transfer a lower level of forces up into the floor and into the lower corner structure of the container including T-floor, foam, inner scuff, bottom side rail and outer scuff. Inner scuff is a protection plate of the lower part of the inner side of the container wall. Outer scuff is a protection plate of the lower part of the outer side of the container wall.

For a planar thin sidewall/body of a crossmember according to an embodiment of the invention, impact energy will make the planar sidewall/body buckle out and the deformation will to a certain degree be undefined and depend on details of the impact forces (e.g. direction). The resulting reduction of forces transferred up into the floor and corner structure will consequently have variations related to how the planar surface have buckled out. For a thin sidewall/body with bendings/embossings, which predefine the place and shape of deformations and by that predetermine where and in which sequence parts of the sidewall/body will bulge out, the reduction of forces transferred up into the floor and corner structure is to a higher degree predetermined and absorption of impact energy can be optimized to a higher level than for the planar buckling body.

Forming a crossmember with reduced thickness dimension for the sidewalls/body of the crossmember brings lower mass of the crossmember and consequently also reduced tare weight for the container, which provides for increased maximum cargo weight. Reduced mass of material for manufacturing of the container leads to reduced production costs.

Prior art designs of crossmembers are omega-profiles (an upside down omega sign having straight lines), C-profiles, Z-profiles, I profiles or squared tube profiles made out of metal sheet materials having one and same wall thickness for all of the profile of the crossmember. The new crossmember profile has a body with reduced thickness and by that reduced critical buckling load compared to the similar profile having same wall thickness for body and flanges, however the new crossmember profile has preferably same stiffness and static load characteristics as the similar crossmember profile having equal thickness for body and flanges. The unchanged stiffness and moment of inertia for the new crossmember profile is achieved by increase of cross-sectional area of the flanges to compensate for the reduced cross-sectional area of the body. The principle of reduction of the critical buckling load of the crossmember profile by reduction of thickness of the body plate, however having the stiffness and the static load characteristics unchanged, can be applied to the various prior art designs of profiles.

In a normal use load case, the crossmember is a simply supported beam, where highest stresses in the profile is at a center part of the profile placed at center of the container base, and in prior art designs this stress level determines the dimensions of the profile all across the container width.

Thus the highest level of stresses at a center part (between ends of the profile) determines the dimensions of the profile all across the container width, and in the parts of the profiles being closer to the side rail, the stresses in the material is then relative lower, said in other words; compared to the design optimized for low weight, there is excess material in the parts of the crossmember between the center and the side rails. In the crossmember according to an embodiment of the invention, this excess material is left out and same overall stiffness of the crossmember is established by use of less material.

Significant reduction of weight and related cost reduction is enabled by implementation of the crossmember according to the invention in a number of 7 crossmembers per container. Further significant reduction of weight and related cost can be realized by implementation of same design principles for a bolster and gooseneck rails.

Further significant reductions of weight and costs is enabled by introduction of new designs of sideposts with similar characteristics as the crossmember having an optimized cross-sectional design with variations of material thickness and with an optimized variation of material thickness in the lengthwise direction of the sideposts going from top to bottom of a sidewall of the container.

Capability to collapse/crumple/buckle under impact conditions is determined by the thickness and effective length and shape of the sidewall/body (body plates), which are parameters having most impact of buckling/crumbling characteristics of the body plate.

Critical buckling load can be determined by Euler's formula. The critical buckling load is proportional to moment of inertia for the body and inverse proportional to the effective height of the body plate (length L in formula below).

Thin body plates enables buckling the most and shapes with bendings/embossings pre-defines the buckling process and pre-defines the results the most.

Euler is also well known in structural engineering for his formula giving the critical buckling load of an ideal strut, which depends only on its length and flexural stiffness

$$F = \frac{{π}^{2} EI}{{( K L )}^{2}} ,$$

Where F=maximum or critical force (vertical load on column),

E=modulus of elasticity,

I=area moment of Inertia,

L=unsupported length of column,

K=column effective length factor, whose value depends on the conditions of end support of the column, as follows
For both ends pinned (hinged free to rotate), K=1,0.
For both ends fixed, K=0.50.
For one end fixed and the other end pinned, K=0,699.
For one end fixed and the other end free to move laterally, K=2.0.
KL is the effective length of the column.

To provide a possibility to reduce distribution of damage caused by impact during handling of containers or when placing containers on uneven surfaces, a new profile is provided.

The invention is achieved by a profile in a container, e.g. a railway container, an intermodal container, a reefer container or a shipping container, where a profile comprising a cross section, where at least a part of the cross section over a length of the profile is provided with a crumple zone, which crumple zone has a critical buckling load being smaller than the critical buckling load for zones abutting the crumple zone.

In an embodiment, the crumple zone is provided in or by a sidewall/body of the profile.

In an embodiment, the crumple zone is provided by the sidewall/body of the profile, which sidewall/body is provided with a material thickness smaller than the thickness of the abutting zones.

In an embodiment, the crumple zone is provided by the sidewall/body of the profile, which sidewall/body is provided with a material strength lower than the material strength of the abutting zones.

In an embodiment, the profile comprises a bottom flange, which bottom flange is provided with a greater material thickness by one or more additional layers of metal sheets being secured to the bottom flange.

In an embodiment, the profile comprises a bottom flange, which bottom flange is provided with a greater material strength by a combined mix of materials, said materials being steel, high strength steel, polymers, or carbon fibers.

In an embodiment, a width of the one or more additional layers of metal sheets secured to the bottom flange corresponds to the width of the bottom flange.

In an embodiment, a width of the one or more additional layers of metal sheets secured to the bottom flange, for at least a part of a length of the bottom flange, are narrower than the width of the bottom flange.

In an embodiment, the crumple zone is provided by means of longitudinal bends in the sidewall/body, which longitudinal bends predefine place and shape of deformations in the crumple zone.

The invention is also achieved by a crumplecrumplemethod for manufacturing a profile for a container, where the method comprises providing a crumple zone crumpleby increasing material thickness in zones of the profile abutting the crumple zone.

In an embodiment, the method further comprises providing the crumple zone in a sidewall/body by laminating a bottom flange of the profile with one or more metal sheets.

In an embodiment, the one or more metal sheets are laminated to the bottom flange of the profile by a thermal joining process, said thermal joining process being welding, stitch welding, or spot welding.

In an embodiment, the one or more metal sheets are laminated to the bottom flange of the profile by a bonding processes, said bonding process being gluing or vulcanizing.

In an embodiment, the one or more metal sheets are laminated to the bottom flange of the profile by rivets or bolts.

In an embodiment where the crumple zone is provided to the profile by means of longitudinal bends in the sidewall/body, which longitudinal bends predefine place and shape of deformations in the crumple zone, the crumplelongitudinal bends is formed by bending, roll forming, embossing or stamping.

The laminating is carried out by providing a layer of elongate sheet metal for example on top of a bottom flange of the profile. Hereby the bottom flange is made stronger and more rigid than other parts of the profile. When the profile afterwards are exposed to impact, the other parts of the profile, most likely sidewalls/body of the profile will crumple, since upper parts, being top flanges of the profile, is fastened to the floor section of the container and the bottom flange is laminated to be stronger.

The invention may also be achieved by a container, e.g. a railway container, an intermodal container, a reefer container or a shipping container comprising side and end walls, a ceiling, a floor section, a door opening, the floor section comprising profiled elements placed in a lengthwise or crosswise direction in relation to a lengthwise direction of the container, the container comprising a profile having a cross section where at least a part of the cross section over a length of the profile is provided with a crumple zone, which crumple zone has a critical buckling load being smaller than the critical buckling load for zones abutting the crumple zone.

In an embodiment, the crumple zone is provided in or by a sidewall/body of the profile.

In an embodiment, a bottom flange in a profile is provided with a greater material thickness by one or more additional layers of metal sheets secured to the bottom flange.

In an embodiment, a width of the one or more additional layers of metal sheets secured to the bottom flange corresponds to the width of the bottom flange of the profile.

In an embodiment, a width of the one or more additional layers of metal sheets secured to the bottom flange of the profile, for at least a part of a length of the bottom flange, are narrower than the width of the bottom flange.

In an embodiment, the crumple zone is provided by maens of longitudinal bends in the sidewall/body, which longitudinal bends predefine place and shape of deformations in the crumple zone of the profile.

The invention is also achieved by a base structure of a container, e.g. a railway container, an intermodal container, a reefer container or a shipping container, which base structure comprises a floor section provided by a pair of bottom side rails, a gooseneck tunnel placed in a front end of the container, a bolster extending at an end of the gooseneck tunnel from one bottom side rail to another, the floor section further comprising at a part of the container base structure running from the bolster to a door end or rear end, a number of crossmembers placed in parallel with the bolster and extending from a bottom side rail in one side of the container to a bottom side rail at the other side of the container, where the crossmember comprises a cross section, where at least a part of the cross section over a length of the crossmember is provided with a crumple zone, which crumple zone has a critical buckling load being smaller than the critical buckling load for zones abutting the crumple zone.

In a simple embodiment, the base structure comprises a floor section provided by a pair of bottom side rails, a front sill in one end and a door sill in an opposite end.

In an embodiment production of profiles, for example crossmember profiles, with variation of thicknesses both along the length of the profile and from top to bottom in the cross-section of the profile is performed out of metal sheets of constant thicknesses laminated in one or more layers, which brings economic advantage due to possibility of using more simple process equipment for manufacture of the profiles and costs related to advanced roll forming of the variations of thicknesses or press equipment is avoided.

By designing the profile to take up damage from an impact instead of transferring the impact to more vital parts of the container, the spreading of damage is limited and preferably held within a preselected area.

The design of crossmembers, bolster, gooseneck rails and sideposts, where variation in material thicknesses along and across the components is enabled by lamination of one of more layers of sheets having constant sheet thickness enables cost efficient production of the components as processes is standard processes such as cutting, stamping, bending, roll forming and welding of standard sheet materials of constant thicknesses on standard and cost efficient production equipment.

The sheets for lamination of one or more layers to a bottom flange of the profile can be shaped as elongate thin plates.

The above and other features and advantages of the present invention will become readily apparent to those skilled in the art by the following detailed description of exemplary embodiments thereof with reference to the attached drawings, in which:

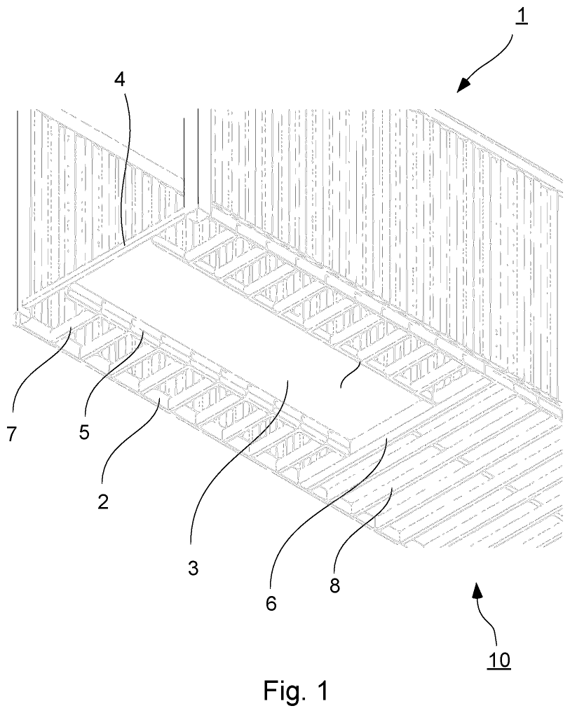

FIG. 1 shows a schematic view of an underside of a container;

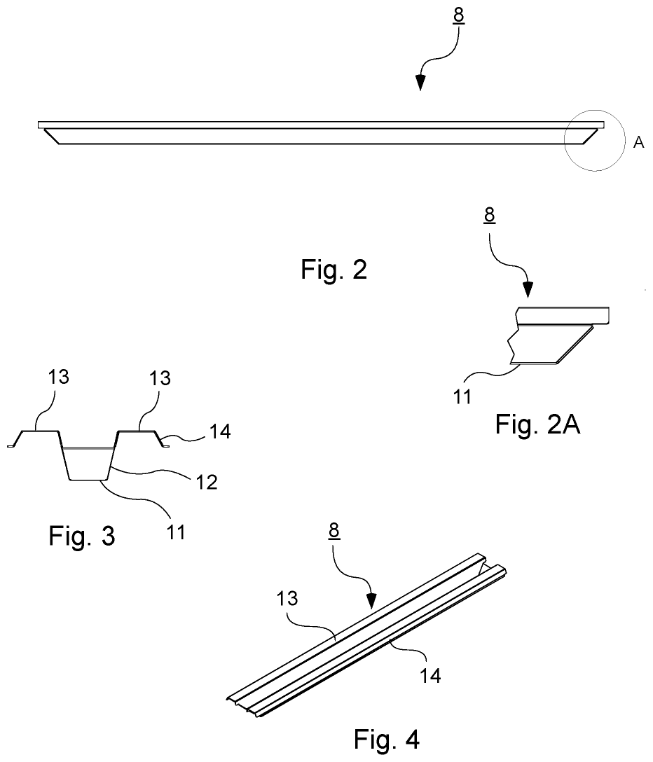

FIG. 2 shows a schematic side view of a crossmember of a container;

FIG. 2A shows schematically an enlarged side view of an end of the crossmember shown on FIG. 2;

FIG. 3 shows schematically an enlarged end view of the crossmember of FIG. 2;

FIG. 4 shows a perspective view of the crossmember of FIG. 2;

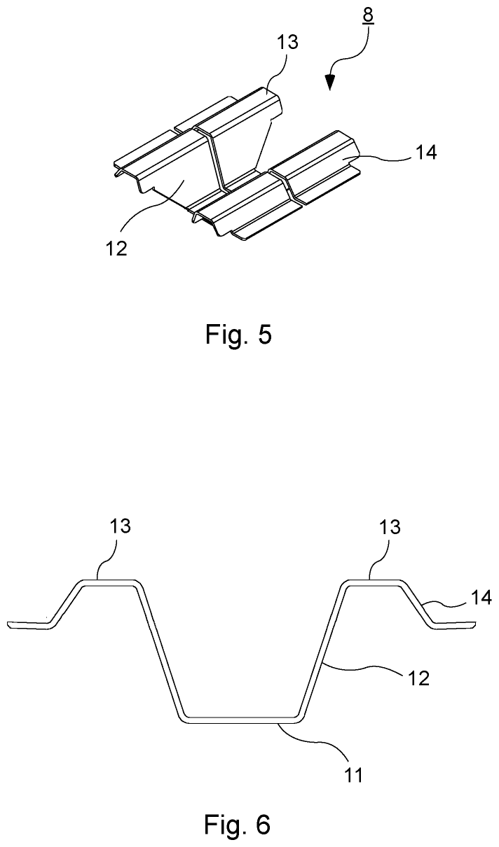

FIG. 5 shows a perspective view of a profile of a prior art crossmember of a container;

FIG. 6 shows a cross section of the prior art profile shown in FIG. 5;

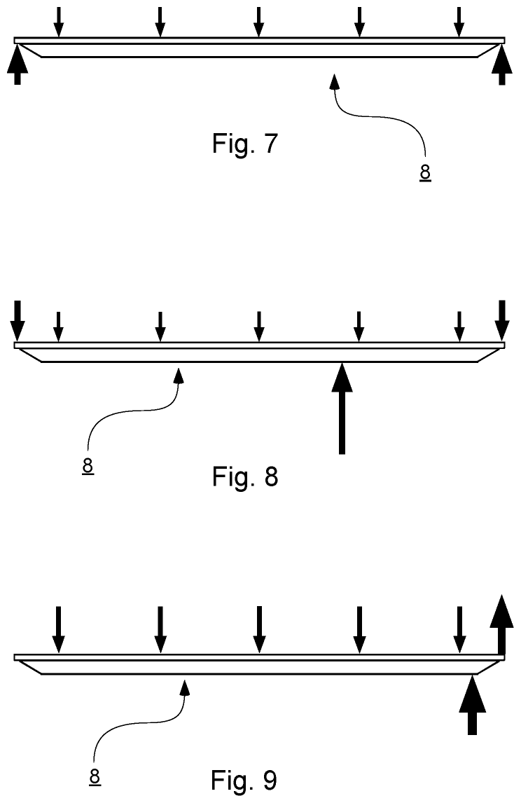

FIG. 7 shows an example of a normal static load situation on a crossmember of a loaded container;

FIG. 8 schematically shows an abnormal static load situation on a cross member of loaded container, for example placed on the ground with a stone or similar obstacle projecting above ground level;

FIG. 9 schematically shows an abnormal impact load situation on a cross member of loaded container, for example when hitting an object during handling of the container;

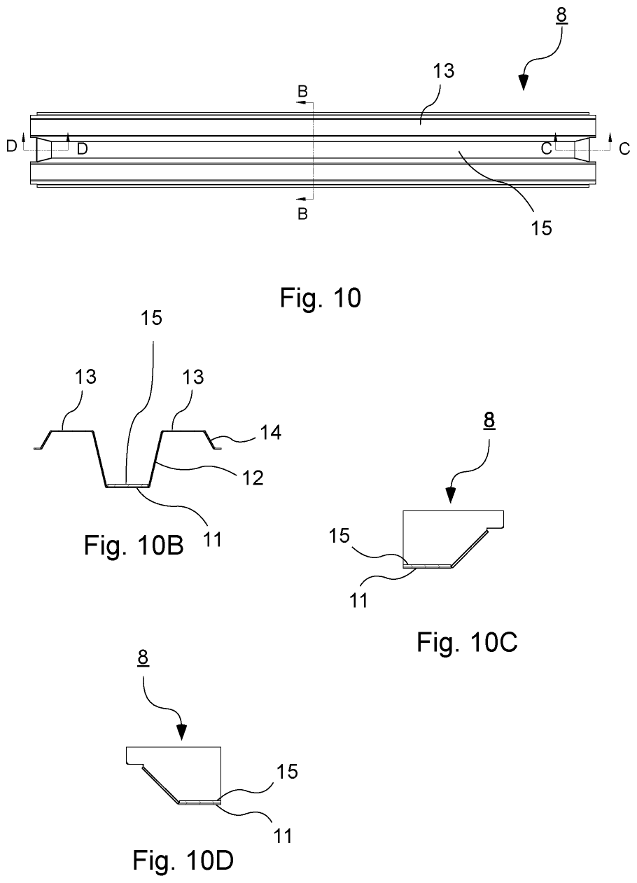

FIG. 10 shows a top view of an embodiment of a crossmember of a container;

FIG. 10B shows a an enlarged cross section along a line B-B of the crossmember shown in FIG. 10;

FIG. 10C shows a cross section along a line C-C of the crossmember shown in FIG. 10;

FIG. 10D shows a cross section along a line D-D of the crossmember shown in FIG. 10;

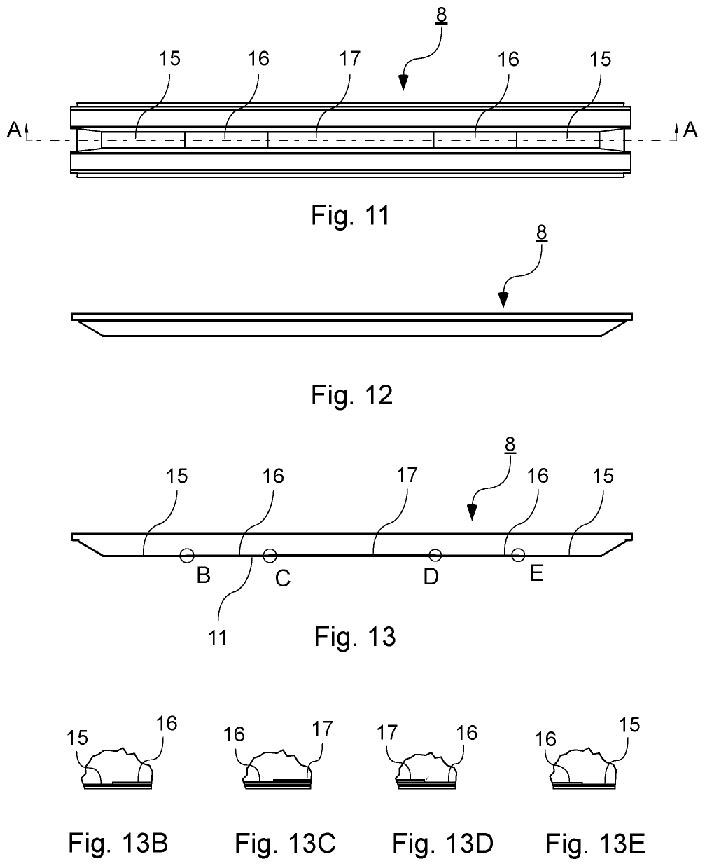

FIG. 11 shows a top view of an embodiment of a crossmember of a container, which crossmember is provided with reinforcement members;

FIG. 12 shows a side view of the crossmember of FIG. 11;

FIG. 13 shows a longitudinal cross section of the crossmember of FIG. 11 along line A-A;

FIG. 13B shows a cut-out of the cross section marked B in the crossmember shown in FIG. 13;

FIG. 13C shows a cut-out of the cross section marked C in the crossmember shown in FIG. 13;

FIG. 13D shows a cut-out of the cross section marked D in the crossmember shown in FIG. 13;

FIG. 13E shows a cut-out of the cross section marked E in the crossmember shown in FIG. 13;

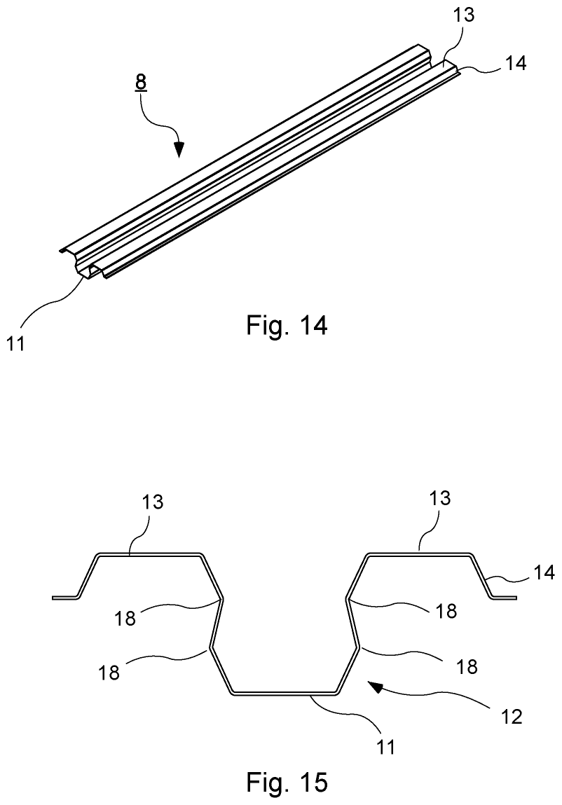

FIG. 14 shows a perspective view of a profile of a middle section of another embodiment of a crossmember of a container;

FIG. 15 shows a cross section or end view of the profile shown in FIG. 14;

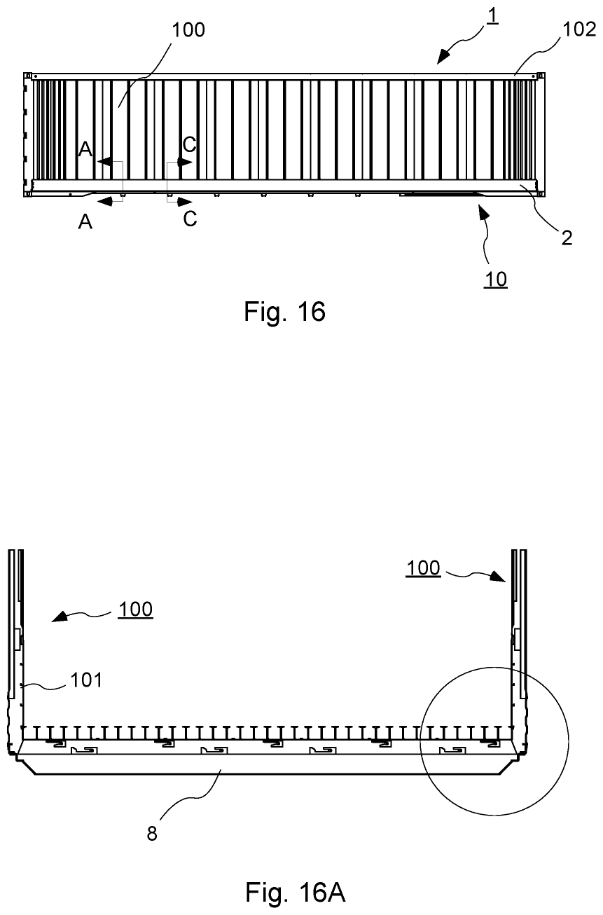

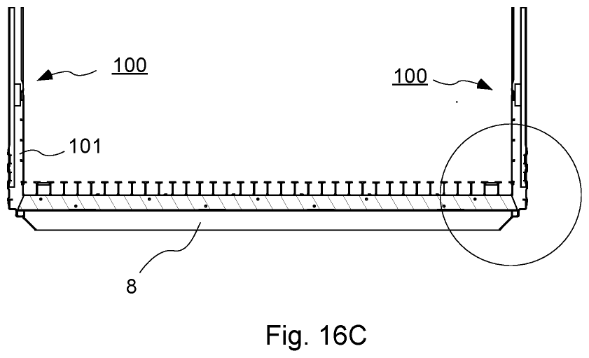

FIG. 16 schematically shows a side view of a container indicating cross sectional views A-A and C-C;

FIG. 16A shows a cross sectional view along line A-A;

FIG. 16C shows a cross sectional view along line C-C;

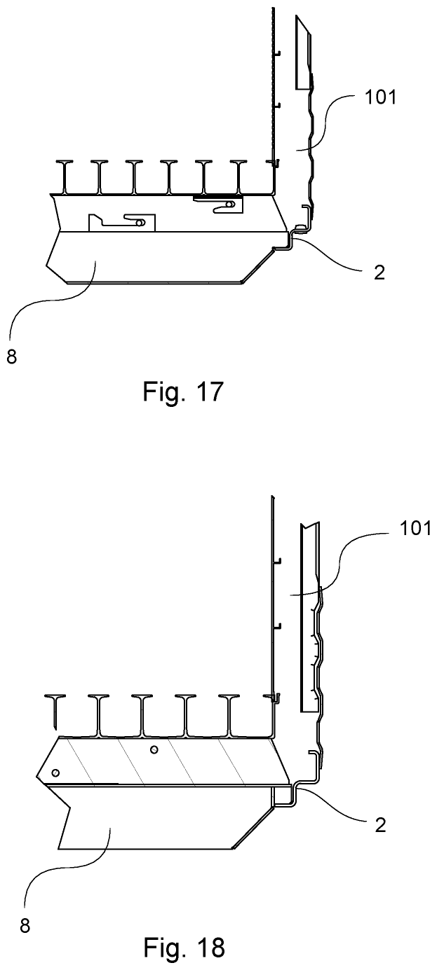

FIG. 17 is a cutout from FIG. 16A showing a lower corner assembly where a crossmember joins a side of the container; and

FIG. 18 is a cutout from FIG. 16C showing a lower corner assembly where a crossmember joins a side of the container.

Various embodiments are described hereinafter with reference to the figures. Like reference numerals refer to like elements throughout. Like elements will, thus, not be described in detail with respect to the description of each figure.

It should also be noted that the figures are only intended to facilitate the description of the embodiments.

They are not intended as an exhaustive description of the claimed invention or as a limitation on the scope of the claimed invention. In addition, an illustrated embodiment needs not have all the aspects or advantages shown.

An aspect or an advantage described in conjunction with a particular embodiment is not necessarily limited to that embodiment and can be practiced in any other embodiments even if not so illustrated, or if not so explicitly described.

Throughout, the same reference numerals are used for identical or corresponding parts.

A base frame construction of a railway container, an intermodal container or a shipping container 1 shown in FIG. 1, comprises a floor section 10 provided by a pair of bottom side rails 2, a gooseneck tunnel 3 placed in an end of the container pointing away from an end provided with one or more doors (not shown) for access to an inner side of the container 1. The gooseneck tunnel 3 is normally defined by a front sill 4, a pair of gooseneck side rails 5 at each side of the gooseneck tunnel 3 and a bolster 6. The bolster forms a transition between a gooseneck end of the container 1 and an opposite end of the container 1, comprising the door end or rear end.

A number of outriggers 7 are distributed between the front sill 4 and the bolster 6 and being parallel to the front sill 4 and the bolster 6. The outriggers extends from a bottom side rail 2 to a gooseneck side rail 5 and are provided at both sides of the gooseneck tunnel 3.

In a simple embodiment, the base frame structure comprises a floor section 10 provided by a pair of bottom side rails 2, a front sill 4 in one end and a door sill in an opposite end.

At a part of the container 1 running from the bolster 6 to the door end or rear end, a number of crossmembers 8 are placed in parallel with the bolster 6 and extending from a bottom side rail 2 in one side of the container 1 to a bottom side rail 2 at the other side of the container 1.

Within the container 1 a floor (not shown) is placed and fastened on top of the floor section 10.

The crossmembers 8, being part of the floor section 10 contributes to the strength of the base frame of the container 1 and to the strength of the container as a whole.

The crossmember 8 of the container 1 is in principle a simply supported beam, which takes the load across the beam and transfer these forces to two end supports being the bottom side rails 2 of the container 1.

There are however other similar load cases in the container structure, where geometries, characteristics and functionalities of the crossmember 8 according to the invention is beneficial and bring improvements to the mechanical properties of the container.

In the front part of the base structure 10 of the container 1 there are no crossmembers 8 mounted as these will collide with the gooseneck tunnel 3, which is in the container 1 to make space for a connection point between trailer and truck. In this area of the gooseneck tunnel 3, the loads of cargo and forklift truck is supported by the bolster 6 and the gooseneck rails 5. The bolster 6 is similar to the crossmembers 8 mounted across the container and transfer the forces to the bottom side rails 2, and the gooseneck side rails 5 in similar way transfer the forces to the bolster 6 in one end and to a bottom front rail or front sill 4 in a front end of the container 1.

In sidewalls 100 of a container 1 there is mounted beams, named sideposts 101 in between bottom side rail 2 and top side rail 102, or in between scuff and top side rail, these beams 101 being part of a sidewall structure comprising side linings and foam similar to the floor structure. Scuff is a protection plate of the lower part of the inner side of the container wall. In this case the load on the sidewall 100 is related to an over-/under pressure in the container, the pressure being a result of temperature differences and/or changes in temperature inside and outside the container 1, or related to changes in atmospheric pressure or wind load outside the container 1.

Variation of moment of inertia in a lengthwise direction of the crossmember 8 according to an embodiment is established by lamination of one or more layers of sheet metal 15, resulting in total higher thickness of the laminated area causing a higher moment of inertia at the center (between ends) of the crossmember 8 and center of the container 1 and lower moment of inertia at the zone near the ends of the crossmember 8 and near the sides of the container 1.

This variation of moment of inertia in the lengthwise direction of the crossmember 8 can also be established by a variation of width of the sheets 15, 16, 17, so at the center of the crossmember 8 at the center of the container 1 the highest moment of inertia is established by having the highest width of the sheets of metal laminated, and the moment of inertia is reduced in the zone near the ends of the crossmember 8 near the side of the container 1 by reduced width of the sheets of metal laminated. In this embodiment, the sheet 15, 16, 17 at least along a part of its length, is narrower than the bottom flange 11.

The crossmember 8 according to the invention comprises a bottom flange 11 and a pair of sidewalls 12 forming a body of the crossmember 8. The sidewalls/body 12 each extend from a side of the bottom flange to a side of the top flange in such a way that the top flanges 13 are placed in a plane parallel to a plane through the bottom flange and pointing away from each other. Each top flange 13 can be provided with a kind of skirt 14. In an embodiment, the skirt 14 can be straight and in another embodiment, the skirt can be bended. Bending the skirt can provide the skirt 14 with enhanced strength or stiffness.

The bottom flange 11 is provided with a greater thickness than the sidewalls/body 12, the top flanges 13 and the skirt 14 (if any).

In an embodiment, the greater thickness is provided by placing and securing a sheet 15 on the bottom flange 11.

In an embodiment, the sheet 15 extend in full length of the bottom flange 11.

In an embodiment, the moment of inertia in the lengthwise direction of the crossmember 8 can be varied by placing and securing one or more sheets 15, 16, 17 on the bottom flange 11 of the crossmember 8.

In an embodiment, the same effect can be achieved with a sheet having Here a first sheet 15 extends in a full length of the bottom flange 11, a second sheet 16 extends from an area B to an area E in FIG. 13 and a third sheet 17 extends from an area C to an area D

In an embodiment the variation of moment of inertia in the lengthwise direction of the crossmember 8 can be established by a variation of width of the sheets 15, 16, 17 so at the center of the crossmember 8 at the center of the container 1 the highest moment of inertia is established by having the highest width of the sheets 15, 16, 17 of metal laminated, and the moment of inertia is reduced in the zone near the ends of the crossmember 8 near the side of the container 1 by reduced width of the sheets 15, 16, 17 of metal laminated. In this embodiment, the sheet 15 or sheetsl5, 16, 17 only along a part of the length, is of the same width as the bottom flange 11.

The moment of inertia can be tailored to the crossmember 8 by selecting a specified length of the one or more sheets 15, 16, 17. FIGS. 11-13 illustrates an example where three sheets of different lengths are placed and secured on the bottom flange 11 of a crossmember 8. Here a first sheet 15 extends in a full length of the bottom flange 11, a second sheet 16 extends from an area B to an area E in FIG. 13 and a third sheet 17 extends from an area C to an area D. The second sheet 16 being shorter than the first sheet 15 and the third sheet 17 being shorter that the second sheet 16.

In an embodiment, the first sheet 15 can be omitted, leaving the ends of the crossmember 8 with its own material thickness.

In an embodiment, the same effect as enforcing the bottom with two or three sheets can be achieved with a sheet having different thicknesses along the length of the sheet. Here a first thickness is provided to the sheet 15 from one end of the bottom flange 11 to the area B, a second (thicker than the first thickness) thickness of the sheet 15 extends from the area B to the area C, a third (thicker than the second thickness) thickness extends from the area C to the area D, a second (thicker than the first thickness) thickness of the sheet 15 extends from the area D to the area E, and a first thickness of the sheet 15 extends from the area E to another end of the bottom flange 11. FIG. 13 is used as an illustrative example.

Securing the one or more sheets 15, 16, 17 to the bottom flange 11 can be done by welding to an inner side of the crossmember 8.

In an embodiment the bottom flange 11 and the top flanges 13 are provided with a greater thickness than the sidewalls/body 12 and the skirt 14 (if any).

The sidewalls/body 12 in the above mentioned embodiments can extend straight from each side of the bottom flange 11 to the top flanges 13 or the sidewalls/body 12 can be provided with one or more bends 18. Also the sidewalls/body 12 can be perpendicular to the bottom flange 11 or the sidewalls/body 12 can incline away from each other in an upwards direction.

The bottom flange 11 having a greater thickness than the sidewalls/body 12, meaning in other words, that the sidewalls/body 12 have a less thickness than the bottom flange 11 leading to less strength of the sidewalls/body 12 compared to the bottom flange 11. In case of an intense impact on the underside of the crossmember 8, the sidewalls/body 12 will start to deform or crumple. The same will occur if the sidewalls/body are bend, for example as illustrated in FIG. 15.

Selecting distances from top or bottom of the sidewall/body 12 being 1/3 of a height of the sidewall/body 12 for placing the bends 18 will enhance the possibility for the sidewall/body 12 to collapse in a controlled manner in the bends 18, when exposed to an intense impact.

The design of the impact absorbing crossmember 8 according to the invention can also be applied to the bolster 6 and to the gooseneck side rails 5 and bring similar benefits regarding absorption of energy related to impact accidents, benefits regarding reduction of tare weight of the container 1 and benefits related to reduction of metal material used for manufacturing the container 1.

The solution is also achieved by a method of manufacturing of a container e.g.

a railway container, an intermodal container, a reefer container or a shipping container, where one or more profiles 5, 6, 7, 8, 101 in the container 1 is provided with a crumple zone according to embodiments mentioned above.

The solution is also achieved by a container, e.g. a railway container, an intermodal container, a reefer container or a shipping container comprising side and end walls, a ceiling, a floor section, a door opening, the floor section comprising profiled elements placed in a lengthwise or crosswise direction in relation to a lengthwise direction of the container, comprising a profile (5, 6, 7, 8, 101) having a cross section where at least a part of the cross section over a length of the profile (5, 6, 7, 8, 101) is provided with a crumple zone according to embodiments mentioned above.

The solution is further achieved by a base structure of a container, e.g. a railway container, an intermodal container, a reefer container or a shipping container, which base structure comprises a floor section 10 provided by a pair of bottom side rails 2, a gooseneck tunnel 3 placed in a front end of the container 1, a bolster 6 extending at an end of the gooseneck tunnel 3 from one bottom side rail 2 to another 2, the floor section further comprising at a part of the container base structure running from the bolster 6 to a door end or rear end, a number of crossmembers 8 placed in parallel with the bolster 6 and extending from a bottom side rail 2 in one side of the container 1 to a bottom side rail 2 at the other side of the container 1, where the crossmember 8 comprises a cross section, where at least a part of the cross section over a length of the crossmember 8 is provided with a crumple zone, which crumple zone has a critical buckling load being smaller than the critical buckling load for zones abutting the crumple zone.

What is claimed is:

1. A profile for a container, the profile comprising a cross-section, wherein at least a part of the cross-section over a length of the profile is provided with a crumple zone, which crumple zone has a critical buckling load being smaller than the critical buckling load of zones abutting the crumple zone.

2. The profile according to claim 1, wherein the crumple zone is provided in or by a sidewall/body of the profile.

3. The profile according to claim 2, wherein the sidewall/body is provided with a material thickness smaller than the thickness of the abutting zones.

4. The profile according to claim 2, wherein the sidewall/body is provided with a material strength lower than the material strength of the abutting zones.

5. The profile according to claim 1, wherein the profile comprises a bottom flange, which bottom flange is provided with a greater material thickness by one or more additional layers of metal sheets being secured to the bottom flange.

6. The profile according to claim 1, wherein the profile comprises a bottom flange, which bottom flange is provided with a greater material strength by a combined mix of materials, said materials being steel, high strength steel, polymers, or carbon fibers.

7. The profile according to claim 5, wherein a width of the one or more additional layers of metal sheets secured to the bottom flange corresponds to the width of the bottom flange.

8. The profile according to claim 5, wherein a width of the one or more additional layers of metal sheets secured to the bottom flange, for at least a part of a length of the bottom flange (11), are narrower than the width of the bottom flange.

9. The profile according to claim 1, wherein the crumple zone is provided by means of longitudinal bends in the sidewall/body, which longitudinal bends predefine place and shape of deformations in the crumple zone.

10. A method for manufacturing a profile for a container, wherein the method comprises providing a crumple zone by increasing material thickness in zones of the profile abutting the crumple zone.

11. The method according to claim 10, wherein the method further comprises providing the crumple zone in a sidewall/body of the profile by laminating a bottom flange of the profile with one or more metal sheets.

12. The method according to claim 11, wherein the one or more metal sheets are laminated to the bottom flange of the profile by a thermal joining process, said thermal joining process being welding, stitch welding, or spot welding.

13. The method according to claim 11, wherein the one or more metal sheets are laminated to the bottom flange of the profile by a bonding process, said bonding process being gluing or vulcanizing.

14. The method according to claim 11, wherein the one or more metal sheets are laminated to the bottom flange of the profile by rivets or bolts.

15. The method according to claim 11, wherein the method comprises forming longitudinal bends by bending, roll forming, embossing, or stamping the sidewall/body.

16. A container comprising one or more profiles according to claim 1.

17. A base structure for a container, which base structure comprises a pair of bottom side rails, a front sill in one end and a door end in an opposite end, a number of crossmembers placed in parallel with the front sill and door end and extending from a bottom side rail in one side of the container to a bottom side rail at the other side of the container, wherein the crossmember comprises a cross-section, wherein at least a part of the cross-section over a length of the crossmember is provided with a crumple zone, which crumple zone has a critical buckling load being smaller than the critical buckling load for zones abutting the crumple zone.
